(19) United States
(12) Patent Application Publication
(10) Pub. No.: US 2005/0100635 A1
(43) Pub. Date: May 12, 2005

(54) Process for enzymatic treatment and filtration of a plant and products obtainable thereby

(76) Inventors: Mark Frederick Firary, Philadelphia, PA (US); Tammy Crowe, East Windsor, NJ (US); Hye Won Yeom, Mount Laurel, NJ (US); Michele Peacock, Marlton, NJ (US); Lewis Kimble, Davis, CA (US); Armando Alvarado, Davis, CA (US)

Correspondence Address: GOODWIN PROCTER L.L.P, 103 EISENHOWER PARKWAY, ROSELAND, NJ, 07068, US

(21) Appl. No.: 10/955,277

(22) Filed: Sep. 30, 2004

Related U.S. Application Data
(60) Provisional application No. 60/508,172, filed on Oct. 1, 2003.

(51) Int. Cl. A23K 1/00

(52) U.S. Cl. 426/53

(57) ABSTRACT

A process for enzymatically treating a plant, such as a fruit, vegetable, or other plant parts (e.g., leaves, stems, roots, tubers, etc.), is disclosed. The process of the invention combines enzyme treatment of the plant with filtration to obtain a permeate and a retentate.

### CROSS-REFERENCE TO RELATED APPLICATIONS

This application claims the benefit of U.S. Provisional Patent Application No. 60/508,172 filed Oct. 1, 2003, which is incorporated by reference herein in its entirety.

### BACKGROUND OF THE INVENTION

1. Field of the Invention

This invention generally relates to a process for enzymatically treating a plant, and, in particular, to a process for filtering an enzyme-treated plant feed material to prepare a nutrient-containing retentate and a juice-containing permeate.

2. Description of the Related Art

Filtration methods have been used in the food processing industry for the production of juice. Typically, a fruit or vegetable is prepared through crushing, dicing, grinding, milling, extracting, enzyme treating and/or other steps into a raw juice, a puree or other processable form that is then filtered to separate a juice-containing permeate from a retentate. The resulting permeate may be used as the juice, or may be concentrated and then frozen and/or stored for later use. The resulting retentate also may be usable for food stuffs.

For example, U.S. Pat. No. 4,551,341 to Blanie et al. describes a process for obtaining a clear plant juice that includes at least two ultrafiltration stages. The plant is first pressed to separate the pulp from a primary (raw) juice. The temperature of the raw juice is adjusted depending on its pH according to a formula that is described in the specification and claims, and typically falls in a range of 50 to 65° C. (about 122 to 149° F.) for pH between about 5 and 3. The temperature-adjusted raw juice is subjected to a first ultrafiltration stage to yield a primary clear juice and a primary pectic concentrate. The primary pectic concentrate (which may be diluted with water) is subjected to a second ultrafiltration stage to yield a second clear juice (which is added to the primary clear juice obtained in the first ultrafiltration stage) and a second pectic concentrate. According to Blanie et al., the juices so obtained are very clear, without a tendency to darken significantly over time, and sterile, which avoids the need for pasteurizations.

In another example, U.S. Pat. No. 4,716,044 to Thomas et al. describes a single pass ultrafiltration process for simultaneously extracting, clarifying and sterilizing juice from fruit. As described by Thomas et al., the fruit is processed into a pumpable puree, and the puree is pumped in a single pass at a specified inlet pressure through a porous tubular housing of a specified length and diameter and having a food grade ultrafiltration membrane secured along the inside surfaces thereof. The ultrafiltration membrane has an initial permeability to water of about 1 to about 15, as defined in the specification and claims.

### BRIEF SUMMARY OF THE INVENTION

The present invention provides improved processes for enzymatically treating and filtering a plant, such as a fruit, vegetable, and other plant parts (e.g., root, tuber, etc.), and products obtainable thereby.

In one embodiment, a plant is washed and treated with a liquefication enzyme to form an enzyme-containing feed. The enzyme-containing feed is concentrated using a filtration unit while the liquefication enzyme is maintained in an active state until a pressure change across the filtration unit begins to decrease. A permeate and a retentate are thereby produced.

In a specific embodiment relating to the processing of sweet potatoes, the sweet potatoes are washed and reduced in size. Water is added to the sweet potatoes to form an aqueous sweet potato mixture which is enzymatically treated to produce a sweet potato feed. The sweet potato feed is filtered to obtain a permeate and a retentate.

### BRIEF DESCRIPTION OF THE DRAWINGS

The figures below depict various aspects and features of the present invention in accordance with the teachings herein.

FIG. 1 is a flow chart that illustrates one embodiment of a process according to the present invention.

FIG. 2 is a flow chart that illustrates another embodiment of a process according to the present invention.

FIG. 3 is a schematic illustration of a preferred system for carrying out a filtration step according to the present invention.

FIG. 4 shows the pressure change of the retentate across the filtration unit (ΔP_{RET}) versus retentate concentration (VRF₀, volume reduction factor with respect to the original volume of the plant) achieved using a process according to the present invention as applied to sweet potato (Δ), kale (⋄), and tomato (∘).

### DETAILED DESCRIPTION OF THE INVENTION

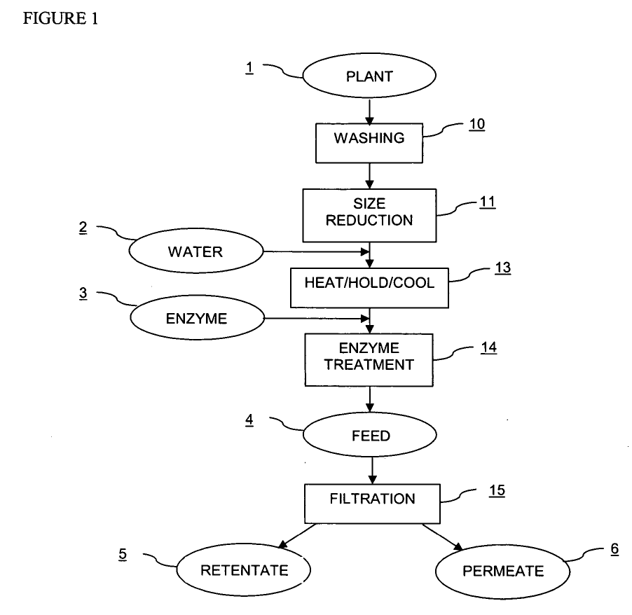

Referring now to FIG. 1, there is shown one embodiment of a process according to the present invention. Although presented as a flowchart, FIG. 1 is not intended to imply that the recited steps must be performed in the order shown, nor is it intended to imply that the present invention requires each of the steps shown.

In step 10, a plant (1) is washed in water to remove dirt. As used herein, “plant” includes fruits, vegetables, or other plant parts, such as leaves, stems, roots, tubers, etc. The skins or outer layers of the plant may be removed if desired, either prior to washing or in a subsequent step, such as an extraction step (not shown).

The plant is typically reduced in size, as shown in step 11. Any conventional size reduction means may be used, such as a hammer mill, dicer, disintegrator, or other mechanism known in the art. Size reduction aids in the release of fluids from the cells of the plant and also allows for more even processing of the plant in subsequent steps.

Water (2) may be added to the plant to form an aqueous plant mixture. The addition of water may aid in the subsequent pre-filtration processing of the plant. Typically, about 0 to about 20 parts water in total is added to about 10 parts plant during the pre-filtration processing according to the present invention. The total amount of water may be added all at once or, as illustrated below, added in parts at different steps of the pre-filtration processing.

An acid may be added with the water to prevent oxidation of the plant, and may also serve to optimize the subsequent enzyme treatment. If an acid is used, any acid or combination of acids that may be consumed by animals and/or humans may be used, and preferably, the acid(s) will not adversely affect the taste of the resulting products. Currently preferred acids include phosphoric acid and citric acid. A reducing agent also may be added with the water to reverse any oxidation and browning that may occur. Any reducing agent or combination of reducing agents that may be consumed by animals and/or humans may be used, and the reducing agent(s) preferably will not adversely affect the taste of the resulting juice. A currently preferred reducing agent is vitamin C.

As shown in FIG. 1, the aqueous plant mixture is subjected to a heat/hold treatment in step 13 to form a plant mash. The plant is heated (typically, with stirring) to soften the plant tissue, which aids the processing of the plant in subsequent steps. The temperature to which the plant is heated and held will vary depending on the plant, though it has been observed that heating to a temperature of at least about 160° F., preferably in a range of about 160° F. to about 200° F., for between about 5 and about 60 minutes is sufficient to soften the tissue of a variety of plants. Depending on the plant being processed, the heat/hold treatment may also cook starch present in the plant (which further aids in subsequent process of the plant) and/or kill undesirable enzymes, such as polyphenyloxidase which contributes to oxidative browning of the plant. In some embodiments, it may be desirable to adjust the temperature of the plant, e.g., by cooling, before proceeding to the next step, as shown in step 13.

A liquefication enzyme (3) is added, and the enzyme-containing plant mash held at a temperature, a pH, and a solids level (substrate concentration) at which the liquefication enzyme is active for a sufficient amount of time for the enzyme to act (typically, with stirring or some shearing action) in an enzyme treatment step, as shown in step 14. A liquefication enzyme includes any enzyme that liquefies plant material (e.g., pectins, cellulose, etc.), and so includes pectinases, cellulases, hemicellulases, pullulanases, amylases, cellubiases, and combinations thereof, as well as other liquefication enzymes known in the art. The particular enzyme or combination of enzymes used depends on the particular plant and plant material(s) targeted.

Each enzyme has optimal temperature, pH, and solids level ranges for its activity, and such information is known or readily available from commercial enzyme providers. When a combination of enzymes is used, generally a temperature, a pH, and a solids level are chosen that optimize the activity of the combination as a whole, rather than of a particular enzyme within the combination. In one embodiment, the temperature, pH, and/or solids level of the plant mash are adjusted to optimal levels, e.g., by the addition of water and/or other means known in the art, prior to the addition of the liquefication enzyme. Other process conditions (e.g., amount of enzyme added, time, atmosphere, etc.) and co-factors (e.g., calcium levels, inhibition factors, etc.) may be varied to optimize enzyme activity.

The enzyme treatment step results in an enzyme-containing feed (4) which is then pumped to a filtration unit where it is concentrated, as shown in step 15. Filtration removes water-insoluble plant components (e.g., carotenoids, other water-insoluble nutrients), which remain in the retentate (5), from the juice-containing permeate (6).

During the filtration step, it may be advantageous to add water to the feed in a diafiltration process. The water may be added at the beginning or end of a concentration run (batch diafiltration), or continuously throughout the concentration run (continuous diafiltration; also known as pulp washing). Diafiltration allows for more of the water-soluble components (e.g., sugars, vitamins, etc.) to be included in the permeate, resulting in higher juice yield per volume of plant. But diafiltration also results in higher volumes of material being run through the filtration unit and so higher processing costs. Whether applying diafiltration is advantageous to a process according to the present invention will depend on the particular economics of each application and can be determined by those of ordinary skill in the art.

It has been surprisingly observed that, if the liquefication enzyme is still active during the filtration step, the enzyme-containing plant feed can be continuously concentrated for much longer periods of time and to greater levels than previously observed, resulting in greater permeate and thus greater juice yields, as well as lower retentate volumes and higher nutrient concentrations.

Without being bound by any particular theory, it is believed that these unexpected benefits result from the combination of active liquefication enzyme in the plant feed and the continuous removal of water and water-soluble components from the plant feed. Some of these water-soluble components are believed to provide alternative binding sites for the active enzyme. Removing these components from the plant feed eliminates a competing pathway for the enzyme's activity. At the same time, removing water increases the concentration of active enzyme in the feed. In effect, it is believed that the combination of these factors increases the concentration of enzyme available for binding to the active plant substrate, driving the enzymatic liquefication of plant material further than prior art enzymatic treatments have been able to achieve. As enzymatic liquefication of plant material (e.g., pectins, celluloses, etc.) continues during filtration, more of the water-insoluble, high molecular weight plant material is broken down into lower molecular weight components, which then can pass through the filtration membrane and so be removed from plant feed and ultimately from the retentate.

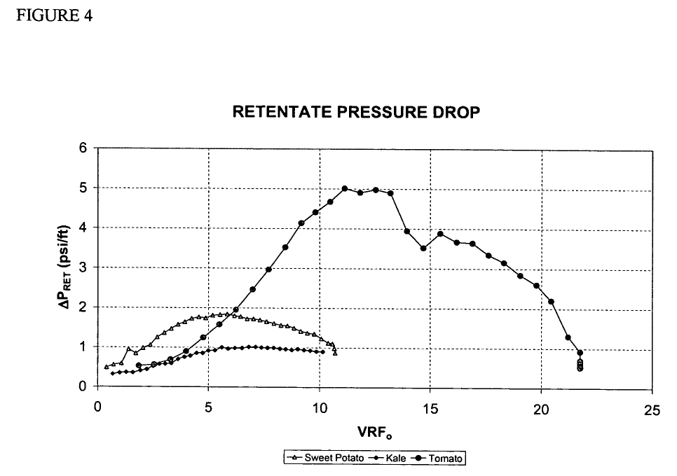

This surprising synergistic result is evidenced by the data shown in FIG. 4. FIG. 4 plots the pressure change of the retentate across the filtration unit (ΔP_{RET}) against the volume reduction factor with respect to the original volume of the plant (VRF₀), which is a measure of how much the retentate is concentrated with respect to the original volume of the plant. Typically, one of skill in the art would expect the retentate pressure change to continuously increase as the retentate becomes more concentrated (i.e., as VRF₀ values increase). Surprisingly, however, when the activity of the liquefication enzyme is maintained in accordance with a process of the present invention, at some concentration level, the retentate pressure change begins to decrease. This surprising result was observed with a variety of plants, including sweet potato (Δ), kale (⋄), and tomato (∘).

The activity of liquefication enzyme in the enzyme-containing feed is typically maintained during the filtration step by maintaining the feed at a temperature and pH level at which the liquefication enzyme is active. As discussed above, each enzyme or combination of enzymes has temperature and pH ranges in which its activity is optimal. In one embodiment, the temperature and pH of the enzyme-containing feed is maintained within the optimal ranges from the enzyme treatment step to and during the filtration step. In cases where the liquefication enzyme is deactivated prior to the filtration step, active liquefication enzyme may be added to the plant feed, and the enzyme-containing feed is maintained within the optimal temperature and pH ranges for the active liquefication enzyme during the filtration step.

The data shown in FIG. 4 for each of sweet potato (Δ), kale (⋄), and tomato (∘) were obtained using the following conditions: treating the plant with a mixture of pectinase, cellulase, and hemicellulase, and maintaining at a temperature in a range of about 130° F. to about 150° F. and a pH of less than about 6.

This surprising synergy results in a retentate that has a smoother, less viscous, more fluid consistency compared to the pulpy, paste-like consistency of plant retentates obtainable from previous filtration methods. The resulting retentate also has a lower volume and a higher nutrient concentration than previously obtained retentates. The use of active liquefication enzyme during filtration in according with a process of the present invention has, in some embodiments, produced nutrient-enriched retentates having at least 700% greater nutrient concentration (i.e., a concentration factor of at least 7), more preferably at least 1000% (i.e., a concentration factor of at least 10), on a solids (dry) basis compared to the original plant.

Compared to other prior art methods of extracting hydrophillic nutrients from a plant, such as solvent extraction and super-critical fluid extraction, the use of active liquefication enzyme during filtration in accordance with a process of the present invention provides a more cost-effective and more environmentally friendly way of obtaining a nutrient-enriched plant product. For example, the process according to the present invention does not require the use of an organic solvent, such as solvent extraction methods do, and so produces a nutrient-enriched product that is suitable for animal and/or human consumption without the need for a costly solvent removal step. The present invention also eliminates the need to use a super-critical fluid, such as super-critical CO₂, which requires expensive equipment to control. Moreover, the nutrient-enriched retentate according to the present invention appears to be more stable to environmental factors, such as temperature, oxygen, light, etc., than the nutrient extracts obtainable from solvent extraction and super-critical fluid extraction.

The retentate obtainable from this process thus has a nutrient content, stability, texture, and consistency that makes it more desirable and more readily usable as a component of a manufactured food product, such as a soup, sauce, etc., than previously obtained plant retentates and nutrient extracts. It may be advantageous to dry the retentate of the present invention, e.g., to inhibit microbial activity. Drying of the retentate may be accomplished using methods known in the art, such as evaporation, oven-drying, freeze-drying, spray-drying, etc.

The permeate obtainable from a process of the present invention contains the plant juice and is typically clear, meaning it has little or no turbidity. Excess water may be removed from the permeate for better storage and stability of the juice. Various water-removal methods are known in the art (e.g., reverse osmosis, evaporation, spray-drying, etc.) and may be used in the present invention. The resulting plant juice concentrate may be used in concentrated form, or it may be reconstituted at a later time with the addition of water. The plant juice may be used, e.g., as a component of a food product, such as a beverage, soup, sauce, etc.

It has been observed that, in some instances, juice that has been reconstituted from the concentrate has a turbidity that was not present when the permeate or concentrate was initially obtained. This typically has been seen after the concentrate has been stored for a period of time. The turbidity appears to be due to the formation of water-insoluble components that precipitate out of the juice. It has also been observed that applying heat to either the enzyme-containing feed or to the permeate (either before or after concentration), followed by a separation step, prevents this turbidity from forming.

Without being bound to any particular theory, it is believed that the application of heat forces the water-insoluble components that cause this turbidity to precipitate out so that they can be removed prior to storage of the concentrate. In cases where the enzyme-containing feed is heated, the filtration step which separates the juice-containing permeate from the retentate simultaneously excludes this water-insoluble precipitate. Where the permeate is heated, this water-insoluble precipitate is observed to form, and an additional separation step (e.g., centrifuging or filtering) is used to remove this precipitate from the juice. Heating the enzyme-containing feed or the permeate to a temperature of at least about 160° F., preferably to a temperature in a range of about 180° F. to about 200° F., for a few minutes has been shown to be effective in preventing turbidity in the reconstituted plant juice.

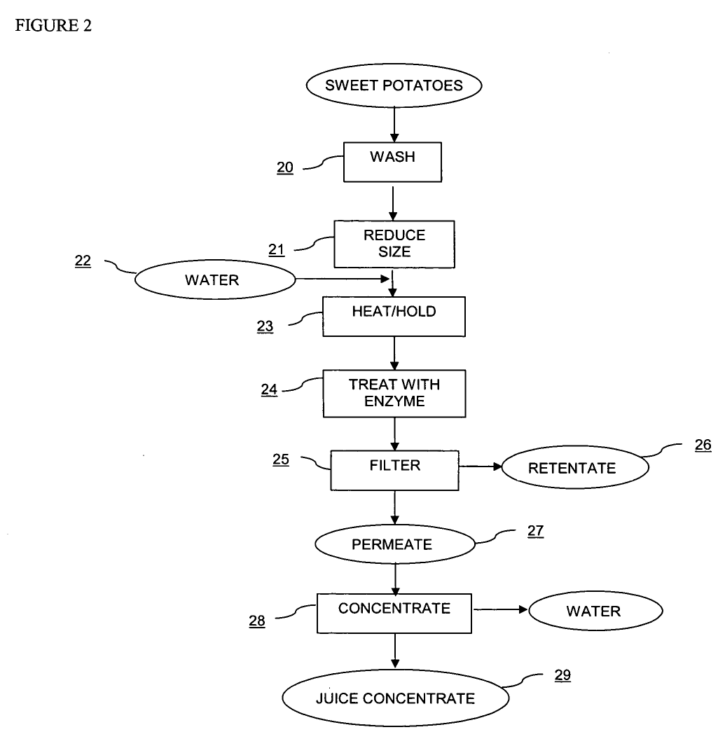

Turning now to FIG. 2, there is shown another embodiment of the present invention that relates particularly to the production of a juice from sweet potatoes. Although presented as a flowchart, FIG. 2 is not intended to imply that the recited steps must be performed in the order shown, nor is it intended to imply that the present invention requires each of the steps shown.

In step 20, the sweet potatoes are washed in water, typically with a mechanical scrubber, to remove soil and dirt from their surfaces. The sweet potatoes are reduced in size in step 21 using any conventional size reduction means, such as a hammer mill.

Water (22) is added to the sweet potatoes to form an aqueous sweet potato mixture. Typically, about 5 to about 20 parts water in total is added to about 10 parts sweet potato during the pre-filtration processing according to the present invention, with the currently preferred amount of water being about 15 parts by weight total to about 10 parts sweet potato. The total amount of water may be added all at once or, as illustrated below, added in parts at different steps of the pre-filtration processing. Preferably, an acid is added with the water to prevent oxidation and browning of the sweet potato, and may also serve to optimize the subsequent enzyme treatment. Currently preferred acids include phosphoric acid and citric acid. More preferably, a reducing agent is also added with the water to reverse any oxidation and browning of the sweet potatoes that may occur. A currently preferred reducing agent is vitamin C.

The aqueous sweet potato mixture is advantageously subjected to a heat/hold treatment in step 23. The aqueous sweet potato mixture is heated (typically, with stirring) to help soften the sweet potatoes and cook the starch in the sweet potatoes, both of which aid the processing of the sweet potatoes in subsequent steps. Typically, the aqueous sweet potato is heated to a temperature of at least about 160° F., the temperature at which the sweet potato starch begins to cook. Preferably, the aqueous sweet potato mixture is heated to a temperature in a range of about 160° F. to about 200° F. and held for a sufficient amount of time to soften the sweet potatoes and cook at least part of the starch. Currently, it is preferred to heat the aqueous sweet potato mixture to a temperature of about 180° F. and hold for about 15 to about 20 minutes.

The sweet potatoes are subjected to an enzyme treatment in step 24. The enzyme treatment may involve endogenous enzymes or exogenous enzymes or both, and may involve combinations of exogenous enzymes.

In one embodiment, the enzyme treatment includes the heat/hold step 23 described previously. Heating the aqueous sweet potato mixture may activate endogenous beta-amylase that convert starch into sugar, specifically into maltose, within the sweet potato.

In another embodiment, an exogenous enzyme is added to the sweet potatoes, and the enzyme-containing sweet potato mixture is held at a temperature and pH at which the exogenous enzyme is active for a sufficient amount of time for the enzyme to act (typically, with stirring or some shearing action). The temperature, pH, and solids level of the sweet potato mixture may be adjusted to optimal levels prior to the enzyme treatment step. Other process conditions (e.g., amount of exogenous enzyme added, time, atmosphere, etc.) and co-factors (e.g., calcium levels, inhibition factors, etc.) may be varied to optimize enzyme activity.

In a particularly preferred embodiment, the exogenous enzyme includes a combination of a liquefication enzyme and a sugar converting enzyme. A liquefication enzyme includes those described previously. A sugar converting enzyme includes any enzyme that converts starch to sugar or one sugar into a different sugar (e.g., maltose to glucose), and so includes alpha-amylase, gluco-amylase, beta-amylase, pullulanase, and combinations thereof as well as others known in the art. The particular combination of enzymes used depends on the particular plant materials targeted and/or the particular combination of sugars desired in the final juice product (e.g., for taste or nutrition reasons).

A currently preferred combination of exogenous enzymes for use with sweet potatoes includes pectinase, cellulase, hemicellulase, and gluco-amylase. When this combination of enzymes is used, the enzyme-containing sweet potato mixture contains about 15 parts added water to about 10 parts sweet potato (by weight) and is held at a temperature in a range of about 130° F. to about 150° F., preferably about 140° F., and a pH less than about 6, preferably in a range of about 4 to about 5, for about 90 minutes.

In embodiments where the sweet potatoes are heated and an exogenous enzyme is to be added, it may be desirable to cool the sweet potatoes before the exogenous enzyme is added. Preferably, the sweet potatoes are adjusted to a temperature at which the exogenous enzyme is active. This may be accomplished through the addition of cold water to the heated sweet potatoes (with the total water added being within the parameters described with regards to the water 22, described above) or by other means known in the art.

The enzymatically treated sweet potatoes are filtered in step 25. Filtration separates a retentate (26) and a permeate (27). The sweet potato retentate is nutrient rich, particularly in beta-carotene content, and is richly colored, and may be used as a nutritional supplement and/or coloring additive to a food product, such as a soup, sauce, etc.

The sweet potato permeate (27) contains the sweet potato juice. Excess water may be removed from the permeate in a concentration step 28 to form a sweet potato juice concentrate (29). The juice concentrate has better stability and may be stored more easily than the juice-containing permeate. The sweet potato juice concentrate may be used in concentrated form, or it may be reconstituted at a later time with the addition of water. The sweet potato juice may be used, e.g., as a flavoring and/or sweetening component of a food product, such as a beverage, soup, sauce, etc.

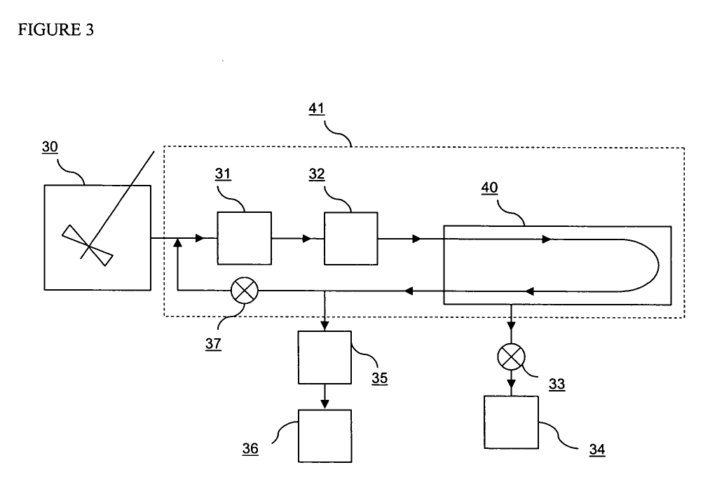

FIG. 3 illustrates a presently preferred system for practicing a filtration step according to the present invention. The system is equipped with hardware and software (some, but not all, of which is shown) that monitor and control various parameters of the filtration process, such as inlet pressure, exit pressure, temperature, flow rate, etc. The enzyme-containing feed material is stored in a feed tank 30 that is equipped with a stirrer or agitator. The feed material is pumped from the feed tank 30 by a recirculation pump 31 through a flow meter 32 into the filtration unit 40. The juice-containing permeate may be removed through a back pressure valve 33 and collected in a permeate tank 34. The retentate may be removed by a metering pump 35 and collected in a retentate tank 36, but is preferably conducted through a back pressure valve 37 and back into the filtration unit 40.

In other words, the system shown in FIG. 3 includes a filtration loop 41 through which the retentate is preferably circulated repeatedly and so continually concentrated, as discussed above. When the system is to be used in this manner, the metering pump 35 is preferably used only once the desired concentration level is reached in order to maintain the retentate at that desired concentration level, which allows the filtration to proceed in a steady-state mode.

The inlet and exit pressures are preferably set to maintain a constant recirculation rate (velocity) and transmembrane pressure in the filtration unit. The inlet pressure typically falls in or below a range of about 30 to about 80 psi, and the exit pressure typically falls in or below a range of about 15 to about 60 psi. Those of ordinary skill in the art will be able to adjust these pressures depending on the viscosity of the feed and the desired recirculation rate.

The filtration unit typically incorporates at least one filtration membrane that has a nominal pore size of less than about 0.5 μm, preferably less than or equal to about 0.1 μm, and an initial water permeability (P), defined as permeate flux (gallons/ft²/day) divided by transmembrane pressure (pounds per square inch, psi), of at least 10.

The present invention is not limited in terms of the types of filters or filtration systems that may be used. It is preferred, especially for industrial scale applications of the present invention, to use a cross-flow filtration membrane. A cross-flow filtration membrane, in which the feed flows parallel to the filtration membrane surface, is particularly well-suited for continuous filtration and higher throughputs. A particularly preferred type of cross-flow filtration membrane is a porous, stainless steel tubular membrane having a sintered titanium dioxide coating, such as the Scepter® filtration module manufactured by Graver Technologies.

The presently preferred filtration unit incorporates three stages of porous, stainless steel cross-flow filtration modules having a nominal pore size of 0.1 μm and ¾″ diameter. Presently, the first two stages are 20′ in length and the third stage somewhat shorter, although the specifications of the filtration unit (e.g., number of filtration stages, diameter and length of the filtration modules, etc.) are not critical to the practice of the present invention and may be varied as desired or needed.

In the manner described above, the present invention thus provides a process for enzymatically treating a plant to produce a plant juice and nutrient-enriched retentate. While this invention has been described with reference to specific embodiments, these are illustrative only and not limiting, having been presented by way of example. Other modifications, including the omission of certain steps and the adaptation and optimization of certain processing parameters, will become apparent to those skilled in the art by study of the specification and drawings. It is thus intended that the following appended claims include such modifications as fall within the spirit and scope of the present invention.

1. A process for enzymatically treating a plant comprising:
a. washing the plant;
b. treating the plant with a liquefication enzyme to form an enzyme-containing feed;
c. while maintaining the liquefication enzyme in an active state in the enzyme-containing feed, concentrating the enzyme-containing feed using a filtration unit until a pressure change across the filtration unit begins to decrease and producing a permeate and a retentate thereby.

2. The process of claim 1, wherein the liquefication enzyme is selected from the group consisting of a pectinase, a cellulase, a hemicellulase, pullulanase, amylase, cellubiase, and combinations thereof.

3. The process of claim 1, wherein treating the plant with the liquefication enzyme comprises adjusting the plant to a temperature and a pH at which the liquefication enzyme is active and combining the plant with the liquefication enzyme.

4. The process of claim 3, wherein maintaining the liquefication enzyme in an active state in the enzyme-containing feed comprises maintaining the enzyme-containing feed at the temperature and the pH at which the liquefication enzyme is active.

5. The process of claim 4, wherein the enzyme-containing feed is maintained at the temperature and the pH at which the liquefication enzyme is active from treating the plant to concentrating the enzyme-containing feed.

6. The process of claim 1, wherein the filtration unit comprises at least one crossflow filtration stage.

7. The process of claim 1, wherein the filtration unit comprises at least one filtration membrane having a nominal pore size of less than about 0.5 μm.

8. The process of claim 1, wherein the filtration unit comprises a filtration loop and concentrating the enzyme-containing feed comprising recirculating the feed through the filtration loop.

9. The process of claim 1, further comprising
f. heating the permeate to a temperature of at least about 160° F., thereby causing a water-insoluble precipitate to form; and
g. separating the precipitate from the permeate.

10. The process of claim 9, wherein separating the precipitate comprises centrifuging the precipitate from the permeate.

11. The process of claim 9, wherein separating the precipitate comprises filtering the precipitate from the permeate.

12. The permeate obtainable from the process of claim 1.

13. A food product prepared from the permeate of claim 12.

14. The retentate obtainable from the process of claim 1.

15. A food product prepared from the retentate of claim 14.

16. A sweet potato process comprising:
a. washing sweet potatoes;
b. reducing the sweet potatoes in size;
c. adding water to the sweet potatoes to form an aqueous sweet potato mixture;
d. enzymatically treating the aqueous sweet potato mixture to form a sweet potato feed; and
e. filtering the sweet potato feed to obtain a permeate and a retentate.

17. The process of claim 16, wherein enzymatically treating the aqueous sweet potato mixture comprises:
i) heating the aqueous sweet potato mixture to at least about 160° F.; and
ii) holding the aqueous sweet potato mixture at at least about 160° F. to activate an endogenous enzyme.

18. The process of claim 16, wherein enzymatically treating the aqueous sweet potato mixture comprises:
i) adjusting the aqueous sweet potato mixture to a temperature and a pH at which an exogenous enzyme is active;
ii) adding the exogenous enzyme to the aqueous sweet potato mixture; and
iii) holding the enzyme-containing sweet potato mixture at the temperature and the pH at which the exogenous enzyme is active.

19. The process of claim 18, wherein the exogenous enzyme is selected from the group consisting of a liquefication enzyme, a sugar-converting enzyme, and combinations thereof.

20. The process of claim 19, wherein the liquefication enzyme is selected from the group consisting of a pectinase, a cellulase, a hemicellulase, and combinations thereof.

21. The process of claim 19, wherein the sugar converting enzyme is selected from the group consisting of a gluco-amylase, an alpha-amylase, a beta-amylase, and combinations thereof.

22. The process of claim 18, wherein the temperature is in a range of about 130° F. to about 150° F.

23. The process of claim 18, wherein the pH is less than about 6.

24. The process of claim 16, further comprising adding a consumable acid to the sweet potato with the water to form the aqueous sweet potato mixture.

25. The process of claim 24, wherein the consumable acid is selected from the group consisting of phosphoric acid and citric acid.

26. The process of claim 24, further comprising adding a consumable reducing agent to the sweet potatoes with the water to form the aqueous sweet potato mixture.

27. The process of claim 26, wherein the consumable reducing agent is vitamin C.

28. The process of claim 16, further comprising:
g. heating the permeate to a temperature in a range of about 160° F. to about 200° F., thereby causing a water-insoluble precipitate to form; and
h. separating the water-insoluble precipitate from the permeate.

29. The process of claim 16, further comprising:
g. prior to filtering, heating the sweet potato feed to a temperature in a range of about 160° F. to about 200° F.

30. The process of claim 16, wherein filtering the sweet potato feed comprises recirculating the sweet potato feed through a filtration loop.

31. The process of claim 30, wherein the filtration loop comprises at least one crossflow filtration stage.

32. The process of claim 30, wherein the filtration loop comprises at least one filtration membrane having a nominal pore size of less than about 0.5 μm.

33. A sweet potato juice obtainable from the process of claim 16.

34. A food product prepared from the sweet potato juice of claim 33.

35. The sweet potato retentate obtainable from the process of claim 16.

36. A food product prepared from the sweet potato retentate of claim 35.
